(19) United States
(12) Patent Application Publication
(10) Pub. No.: US 2026/0333494 A1
(43) Pub. Date: Oct. 22, 2026

(54) MULTIPLE ACCESS (MA) PACKET DATA NETWORK (PDN) REQUEST

(71) Applicant: Lenovo (United States) Inc., Morrisville, NC (US)

(72) Inventor: Roozbeh Atarius, La Jolla, CA (US)

(73) Assignee: Lenovo (United States) Inc., Morrisville, NC (US)

(21) Appl. No.: 19/285,737

(22) Filed: Jul. 30, 2025

(51) Int. Cl. H04W 76/19

(52) U.S. Cl. CPC H04W 76/19

(57) ABSTRACT

Various aspects of the present disclosure relate to multiple access (MA) packet data network (PDN) request. A user equipment (UE) transmits a first request for establishment of MA PDN connectivity, the first request including a first protocol configuration options (PCO) information element (IE) or a first extended PCO (ePCO) IE. The first PCO IE or the first ePCO IE includes one or more access traffic steering, switching, splitting (ATSSS) modes supported by the UE. The UE receives an indication of a rejection of the first request, the indication including an indication of semantically incorrect message.

### TECHNICAL FIELD

The present disclosure relates to wireless communications, and more specifically to multiple access (MA) in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may be configured to, capable of, or operable to transmit a first request for establishment of MA packet data network (PDN) connectivity, the first request including a first protocol configuration options (PCO) information element (IE) or a first extended PCO (ePCO) IE, where the first PCO IE or the first ePCO IE includes one or more access traffic steering, switching, splitting (ATSSS) modes supported by the UE; and receive an indication of a rejection of the first request, the indication including an indication of semantically incorrect message.

A processor (e.g., a standalone processor chipset, or a component of a UE) for wireless communication is described. The processor may be configured to, capable of, or operable to perform one or more operations as described herein. For example, the processor may be configured to, capable of, or operable to transmit a first request for establishment of MA PDN connectivity, the first request including a first PCO IE or a first ePCO IE, where the first PCO IE or the first ePCO IE includes one or more ATSSS modes supported by the UE; and receive an indication of a rejection of the first request, the indication including an indication of semantically incorrect message.

A method performed or performable by a UE for wireless communication is described. The method may include transmitting a first request for establishment of MA PDN connectivity, the first request including a first PCO IE or a first ePCO IE, where the first PCO IE or the first ePCO IE includes one or more ATSSS modes supported by the UE; and receiving an indication of a rejection of the first request, the indication including an indication of semantically incorrect message.

In some implementations of the UE, the processor, and the method described herein, the indication of the rejection of the first request includes an evolved packet system (EPS) session management (ESM) cause value #95“Semantically incorrect message.”

In some implementations of the UE, the processor, and the method described herein, the indication of the rejection of the first request includes a private notify message of an error type “SEMANTICALLY_INCORRECT_MESSAGE”.

In some implementations of the UE, the processor, and the method described herein, the indication of the rejection of the first request includes a second PCO IE or a second ePCO IE, the second PCO IE or the second ePCO IE includes an ATSSS status associated with the rejection of the first request, and where the ATSSS status includes an indication of semantically incorrect message.

In some implementations of the UE, the processor, and the method described herein, the ATSSS status is indicated in the second ePCO IE via a parameter including two octets of bits.

In some implementations of the UE, the processor, and the method described herein, the one or more ATSSS steering modes supported by the UE include an indication of multipath quick user datagram protocol (UDP) connections (QUIC) for internet protocol (IP) packets (MPQUIC-IP) functionality with steering mode without ATSSS-lower layer (LL) functionality.

In some implementations of the UE, the processor, and the method described herein, the first request is transmitted to one of a mobility management entity (MME) or an evolved packet data gateway (ePDG).

A first NE (e.g., a base station) for wireless communication is described. The first NE may be configured to, capable of, or operable to perform one or more operations as described herein. For example, the first NE may be configured to, capable of, or operable to transmit a first request for establishment of MA PDN connectivity for a UE, the first request including a first PCO IE or a first ePCO IE, where the first PCO IE or the first ePCO IE includes one or more ATSSS modes supported by the UE; receive a first message including a first indication of a rejection of the first request; and transmit a second message including a second indication of a rejection of the first request, the second indication including an indication of semantically incorrect message.

A processor (e.g., a standalone processor chipset, or a component of a first NE) for wireless communication is described. The processor may be configured to, capable of, or operable to perform one or more operations as described herein. For example, the processor may be configured to, capable of, or operable to transmit a first request for establishment of MA PDN connectivity for a UE, the first request including a first PCO IE or a first ePCO IE, where the first PCO IE or the first ePCO IE includes one or more ATSSS modes supported by the UE; receive a first message including a first indication of a rejection of the first request; and transmit a second message including a second indication of a rejection of the first request, the second indication including an indication of semantically incorrect message.

A method performed or performable by a first NE (e.g., a base station) for wireless communication is described. The method may include transmitting a first request for establishment of MA PDN connectivity for a UE, the first request including a first PCO IE or a first ePCO IE, where the first PCO IE or the first ePCO IE includes one or more ATSSS modes supported by the UE; receiving a first message including a first indication of a rejection of the first request; and transmitting a second message including a second indication of a rejection of the first request, the second indication including an indication of semantically incorrect message.

In some implementations of the first NE, the processor, and the method described herein, the second indication comprises a cause value comprising an ESM cause value #95“Semantically incorrect message.”

In some implementations of the first NE, the processor, and the method described herein, the second indication comprises a private notify message of an error type “SEMANTICALLY_INCORRECT_MESSAGE”.

In some implementations of the first NE, the processor, and the method described herein, the second indication comprises a second PCO IE or a second ePCO IE comprising an ATSSS status associated with the rejection of the first request, where the ATSSS status comprises an indication of semantically incorrect message.

In some implementations of the first NE, the processor, and the method described herein, the ATSSS status is indicated in the second ePCO IE via a parameter comprising two octets of bits.

In some implementations of the first NE, the processor, and the method described herein, the first NE comprises one of an MME or an ePDG.

In some implementations of the first NE, the processor, and the method described herein, the first indication of the rejection of the first request comprises an indication of a mandatory IE missing.

A second NE (e.g., a base station) for wireless communication is described. The second NE may be configured to, capable of, or operable to perform one or more operations as described herein. For example, the second NE may be configured to, capable of, or operable to receive a first request for establishment of MA PDN connectivity for a UE, the first request comprising a first PCO IE or a first ePCO IE, where the first PCO IE or the first ePCO IE comprises one or more ATSSS modes of the UE; and transmit a first message comprising an indication of a rejection of the first request, the first message comprising an indication of ATSSS status of semantically incorrect message.

A processor (e.g., a standalone processor chipset, or a component of a second NE) for wireless communication is described. The processor may be configured to, capable of, or operable to perform one or more operations as described herein. For example, the processor may be configured to, capable of, or operable to receive a first request for establishment of MA PDN connectivity for a UE, the first request comprising a first PCO IE or a first ePCO IE, where the first PCO IE or the first ePCO IE comprises one or more ATSSS modes of the UE; and transmit a first message comprising an indication of a rejection of the first request, the first message comprising an indication of ATSSS status of semantically incorrect message.

A method performed or performable by a second NE (e.g., a base station) for wireless communication is described. The method may include receiving a first request for establishment of MA PDN connectivity for a UE, the first request comprising a first PCO IE or a first ePCO IE, where the first PCO IE or the first ePCO IE comprises one or more ATSSS modes of the UE; and transmitting a first message comprising an indication of a rejection of the first request, the first message comprising an indication of ATSSS status of semantically incorrect message.

In some implementations of the second NE, the processor, and the method described herein, the ATSSS status is indicated in a second ePCO IE via a parameter comprising two octets of bits.

In some implementations of the second NE, the processor, and the method described herein, the second NE comprises a PDN gateway (PGW) control plane (PGW-C) plus session and mobility management function (SMF) (PGW-C+SMF).

In some implementations of the second NE, the processor, and the method described herein, the first message is transmitted to an MME or an ePDG.

### BRIEF DESCRIPTION OF THE DRAWINGS

FIG. 1 illustrates an example of a wireless communications system in accordance with aspects of the present disclosure.

FIG. 2 illustrates an example system in accordance with aspects of the present disclosure.

FIG. 3 illustrates an example signaling diagram in accordance with aspects of the present disclosure.

FIG. 4 illustrates an example signaling diagram in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method in accordance with aspects of the present disclosure.

FIG. 9 illustrates a flowchart of a method in accordance with aspects of the present disclosure.

FIG. 10 illustrates a flowchart of a method in accordance with aspects of the present disclosure.

### DETAILED DESCRIPTION

In a wireless communications network, some devices may support wireless communication using time-frequency resources. These devices may also be configured to operate in accordance with wireless standards (e.g., 3GPP) and may be referred to as 3GPP devices. The wireless communications network may further support MA techniques, in which time-frequency resources may be used for wireless communication with other devices that do not support wireless standards (e.g., 3GPP). These devices may be referred to as non-3GPP devices. A non-3GPP device may represent a UE that lacks the functionality to directly connect to a 3GPP-network. In such scenarios, a non-3GPP device may connect to a 3GPP device to obtain connectivity to the 3GPP network, a method referred to as device tethering. In device tethering implementations, a 3GPP device may establish an IP tunnel between the 3GPP network and the non-3GPP device to enable the exchange (e.g., transmission and reception) of information (e.g., control information, data) between the 3GPP network and the non-3GPP device.

In MA implementations, traffic steering (also referred to herein as “steering”) can be performed to manage data traffic across different device and network resources. For example, steering can be used to route data flows between different types of data networks, such as between 3GPP networks (e.g., wireless cellular networks) and non-3GPP networks (e.g., WiFi networks). Steering can also be used to adapt to various conditions, such as to route and reroute data traffic based on conditions such as network delay, network load, or data priority. In some wireless communications networks, ATSSS protocols can be utilized to perform steering operations. ATSSS can provide rules and parameters for controlling steering based on dynamic network and data flow conditions. MPQUIC protocols can also be used for steering using different connectivity types, including 3GPP connectivity and non-3GPP connectivity. Some wireless communications networks, however, may encounter challenges in implementing steering functionality when wireless standards (e.g., 3GPP) evolve, which may result in compatibility issues between devices that are compliant with different versions of the wireless standards. For example, changes introduced in steering functionalities and steering modes in Release 19 of 3GPP may result in changes to the structure of earlier releases of 3GPP (e.g., Release 18 and beyond), potentially causing certain networks to misinterpret a UE request for establishing a MA PDU session.

Aspects of the present disclosure are described in the context of a wireless communications system and include implementations that provide for mapping cause values associated with MA PDU session establishment. For example, for scenarios involving 3GPP-based access to EPS, a mapping between the cause value #70 “Mandatory IE missing” to the ESM cause value set to #95 “Semantically incorrect message” can be generated, such as by the MME. For scenarios involving non-3GPP access (e.g., untrusted access) to EPS, a private notify message of an error type “SEMANTICALLY_INCORRECT_MESSAGE” can be generated by the ePDG for mapping the cause value #70 “Mandatory IE missing.” In implementations, an encoding is generated for the ATSSS parameter ATSSS status for “Semantically incorrect message” to be communicated between the PGW-C+SMF and the UE in the ATSSS response. The encoding, for example, has a length of two octets in PCO parameter container contents in an ePCO IE.

By performing the described techniques, devices in a wireless communications system (UEs, NEs) can achieve interoperability between the devices that operate according to different versions of standards, which can reduce miscommunication and misinterpretation of communications between the devices.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

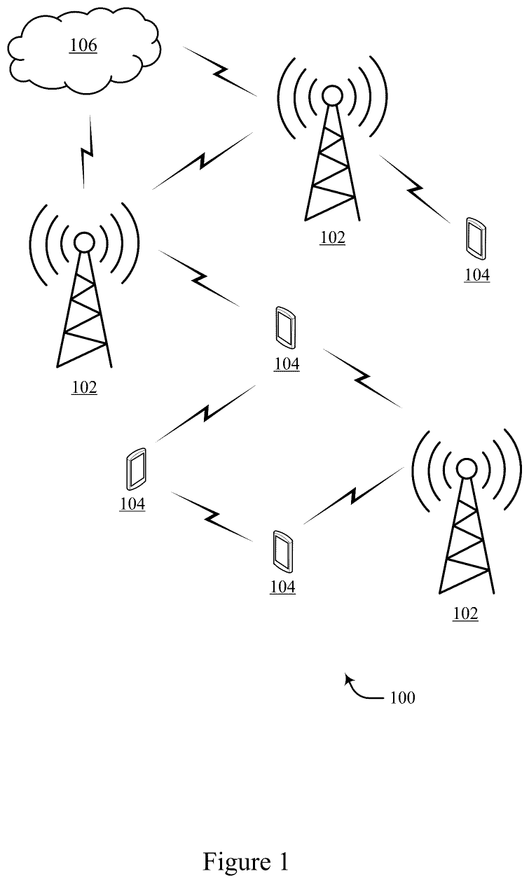

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a MME, an access and mobility management functions (AMF)) and a user plane entity that routes packets or interconnects to external networks (e.g., a serving gateway (S-GW), a PDN gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 transmits a first request for establishment of MA PDN connectivity, the first request including a first PCO IE or a first ePCO IE, and the first PCO IE or the first ePCO IE including one or more ATSSS modes supported by the UE. The UE 104 receives an indication of a rejection of the first request, the indication including an indication of semantically incorrect message.

According to implementations, a first NE 102 (e.g., MME, ePDG) transmits a first request for establishment of MA PDN connectivity for a UE 104, the first request including a first PCO IE or a first ePCO IE. The first PCO IE or the first ePCO IE includes one or more ATSSS modes supported by the UE 104. The first NE 102 receives a first message comprising a first indication of a rejection of the first request and transmits a second message comprising a second indication of a rejection of the first request, the second indication including an indication of semantically incorrect message.

According to implementations, a second NE 102 (e.g., PGW-C+SMF) receives a first request for establishment of MA PDN connectivity for a UE 104, the first request including a first PCO IE or a first ePCO IE. The first PCO IE or the first ePCO IE includes one or more ATSSS modes of the UE 104. The second NE 102 transmits a first message comprising an indication of a rejection of the first request, the first message including an indication of ATSSS status of semantically incorrect message.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

In some wireless communications systems regarding 3GPP TS, for release 18 and onwards a new set of steering functionalities and steering modes have been created for MA PDU session in addition to the already existing ATSSS-ST rules in rel-17 of 3GPP Technical Specification (TS) 24.501. (See 3GPP TS 24.501, “Non-Access-Stratum (NAS) protocol for 5G System (5GS); Stage 3,” v. 19.3.0, 2 Jul. 2025, hereinafter “TS 24.501”). By that, it was agreed that then existing defined steering functionalities and steering modes were removed from rel-18 onwards.

Changes introduced in CT1 #153 to 3GPP TS 24.501 introduced a new explicit parameter that the UE at the minimum supports “ATSSS-LL functionality with Active Standby steering mode”. Although the support of “ATSSS-LL functionality with Active Standby steering mode” is valid for the UPF and used to be valid for the UE for previous releases than rel-19, according to the new stage 2 parameter in 3GPP TS 23.501 for rel-19 (See 3GPP TS 23.501, “System architecture for the 5G System (5GS)” v. 19.4.0, 19 Jun. 2025, hereinafter “TS 23.501”), the UE shall be capable to choose any of the steering functionality and steering mode from the following list:
1—ATSSS-LL functionality with any steering mode
2—MPTCP functionality with any steering mode and ATSSS-LL functionality with only Active-Standby steering mode
3—MPQUIC-UDP functionality with any steering mode and ATSSS-LL functionality with only Active-Standby steering mode
4—MPQUIC IP functionality with any steering mode without any ATSSS-LL functionality
5—MPQUIC IP functionality with any steering mode and ATSSS-LL functionality with only Active-Standby steering mode
6—MPQUIC-E functionality with any steering mode and ATSSS-LL functionality with only Active-Standby steering mode

The 4^{th} element in the above list, “MPQUIC IP functionality with any steering mode without any ATSSS-LL functionality” does not require that the UE supports “ATSSS-LL functionality with Active Standby steering mode”.

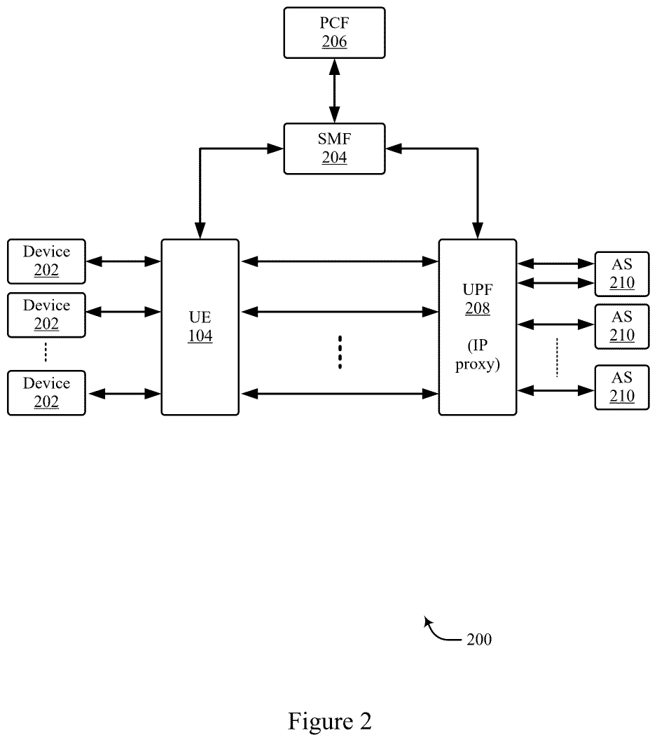

FIG. 2 illustrates an example system 200 in accordance with aspects of the present disclosure. The system 200 can be implemented to enable devices 202 to transmit and receive data packets via a wireless cellular network, e.g., 3GPP network. In the system 200, the devices 202 are connected to a UE 104, such as via a wireless and/or wired connection. The devices 202 may represent devices that do not have the capability to directly connect with a wireless cellular network. Examples of the devices 202 include tablet computers, laptop computers, desktop computers, internet of things (IoT) devices, etc. The UE 104 may communicate with an SMF 204 to request PDU session establishment, and the SMF 204 may communicate with a PCF 206 to obtain policy information for the PDU session. Based on the obtained policy information, the UE 104 may establish UDP flows with a UPF 208, which can enable IP packets to be communicated via the UE 104 between the devices 202 and application servers (AS) 210.

Relaxing the parameter for support of ATSSS_LL functionality on the UE side can be demonstrated in the system 200 where the UE 104 is used to pass the IP packets to the internet for the devices 202 without capability to connect to the cellular network, e.g., tethering. In such scenarios, stage 2 involves the UE 104 using “MPQUIC IP functionality with any steering mode without any ATSSS-LL functionality” at the time of MA PDU session establishment.

In the system 200, the UE 104 may be capable of MPQUIC steering functionality for the IP packets which are transmitted to between the devices 202 and the network. Since TS 23.501 specifies that the ATSSS UE may be capable of a steering functionality, it is not required for the UE to implement ATSSS-LL functionality with any of the steering modes defined in TS 23.501. The change of the ATSSS parameters in rel-19 and the newly adopted structure for rel-18 onwards which was agreed in rel-18 onwards of TS 24.501 introduced a mismatch between the behavior of rel-18 onwards UE and the legacy and non-legacy network. Therefore, in CT1 #154, a set of documents (i.e., C1-252532 for rel-16, C1-252105 for rel-17, C1-252565 for rel-18, and C1-252564 for rel-19) were agreed upon to resolve the mismatch by defining a new abnormal behavior for the network if receiving a MA PDU session establishment request with misinterpreted steering functionality and steering mode due to the mismatch. The solution in C1-252532 for rel-16, C1-252105 for rel-17, C1-252565 for rel-18, and C1-252564 for rel-19 are for 5GS and cannot be used for resolving the same issue in EPS with 3GPP access or untrusted non-3GPP access, and the solutions described in this disclosure can be implemented for resolving these issues with the mismatch of ATSSS parameters when the UE is connected to EPS.

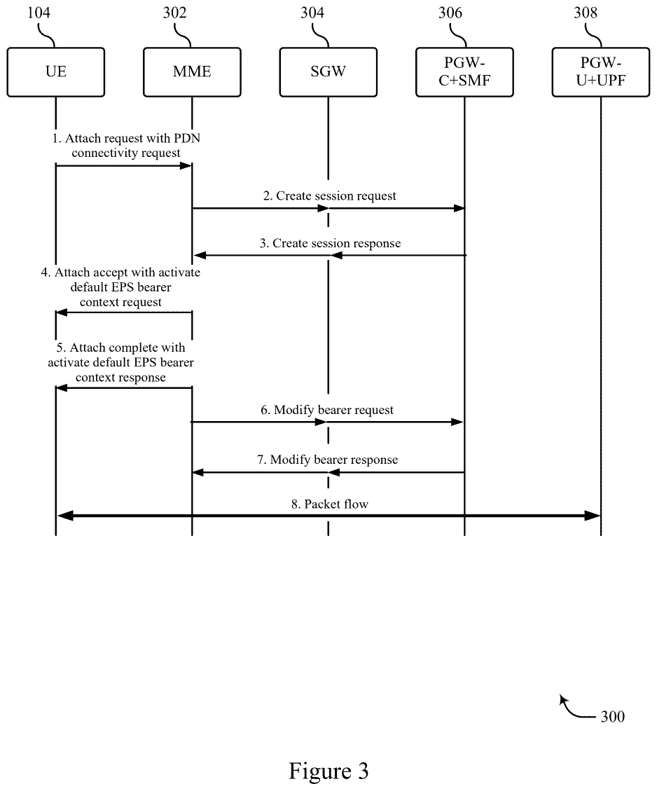

FIG. 3 illustrates an example signaling diagram 300 in accordance with aspects of the present disclosure. 3GPP TS 24.193 and 3GPP TS 23.316 identify that the MA PDU connectivity service may have one of its accesses in the EPS back to release 16. (See 3GPP 24.193 “5G System; Access Traffic Steering, Switching and Splitting (ATSSS); Stage 3” v. 19.3.0, 3 Jul. 2025, hereinafter “TS 24.193; See also 3GPP TS 23.316 “Wireless and wireline convergence access support for the 5G System (5GS)” v. 19.2.0, 19 Jun. 2025, hereinafter “TS 23.316.”)

However, the MA PDU connectivity service with a connection via the untrusted non-3GPP access goes back to release 18 according to TS 24.193 and 3GPP TS 24.302 (See 3GPP TS 24.302 “Access to the 3GPP Evolved Packet Core (EPC) via non-3GPP access networks; Stage 3” v. 19.0.0, 1 Jul. 2025, hereinafter “TS 24.302”). The signaling diagram 300 illustrates PDN connection in EPS via 3GPP access, including a simplified version of attach procedure in 3GPP network as specified in TS 3GPP 23.401 with the PDN connection which occurs during the attach procedure. (See 3GPP TS 23.401 “General Packet Radio Service (GPRS) enhancements for Evolved Universal Terrestrial Radio Access Network (E-UTRAN) access” v. 19.3.0, 19 Jun. 2025, hereinafter “TS 23.401”).

In the signaling diagram 300, at step 1 a UE 104 transmits, to an MME 302, an attach request with a PDN connectivity request. At step 2, the MME 302 transmits, via a serving gateway (SGW) 304, a create session request to a PGW-C+SMF 306. At step 3, the PGW-C+SMF 306 transmits, via the SGW 304, a create session response to the MME 302. At step 4, the MME 302 transmits, to the UE 104, an attach accept notification with an activate default EPS bearer context request. At step 5, the UE 104 transmits, to the MME 302, an attach complete notification with an activate default EPS bearer context response. At step 6 the MME 302 transmits, via the SGW 304, a modify bearer request to the PGW-C+SMF 306. At step 7 the PGW-C+SMF 306 transmits, via the SGW 304, a modify bearer response to the MME 302. In implementations, at step 8 a packet flow may be established between the UE 104 and a packet gateway user plane (PGW-U) and user plane function (UPF) 308.

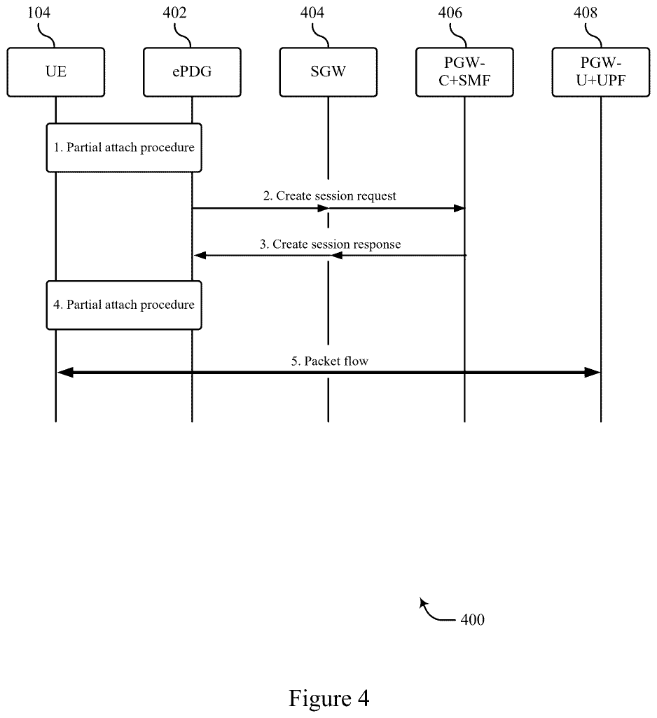

FIG. 4 illustrates an example signaling diagram 400 in accordance with aspects of the present disclosure. The signaling diagram 400, for example, illustrates PDN connection in EPS via an untrusted non-3GPP, and includes an attach procedure and the PDN connection in EPS via untrusted non-3GPP access network. In the signaling diagram 400, at step 1 the UE 104 and an ePDG 402 perform a partial attach procedure. At step 2, the ePDG 402 transmits, via a SGW 404, a create session request to a PGW-C+SMF 406. At step 3, the PGW-C+SMF 406 transmits, via the SGW 404, a create session response. At step 4, the UE 104 and an ePDG 402 perform another partial attach procedure. In implementations, at step 5 a packet flow may be established between the UE 104 and a PGW-U+UPF 408. In implementations, the partial attach procedure in step 1 and step 4 may refer to the initial attach with PMIPv6 on S2b procedure in clause 7.2.1 in 3GPP TS 23.402. (See 3GPP TS 23.402 “Architecture enhancements for non-3GPP accesses” v. 18.3.0, 19 Dec. 2023, hereinafter “TS 23.402”).

In implementations, (e.g., as illustrated in step 2 of the signaling diagrams 300, 400) the PGW-C+SMF receives an activation request for a MA PDU connectivity service via the create session request message including the ePCO IE with the ATSSS request PCO parameter, e.g., as defined in TS 24.193. In some scenarios, such as due to changes in the ATSSS parameters for steering functionalities in rel-19 and adopted structure for rel-18 onwards for the ATSSS PCO parameter, a PGW-C+SMF from earlier releases than rel-19 may interpret that the ePCO IE with the ATSSS request PCO parameter:
indicates “ATSSS not supported” as defined in TS 24.193; or
does not indicate any steering functionality or steering mode as defined in TS 24.193.

In some implementations, the PGW-C+SMF from earlier releases than rel-19 may reject the PDN connection establishment procedure by generating the create session response message as shown in step 3 of the signaling diagrams 300, 400. The create session response message may include the cause value set to #70 “Mandatory IE missing” as defined in 3GPP TS 29.274. (See 3GPP TS 29.274 “3GPP Evolved Packet System (EPS); Evolved General Packet Radio Service (GPRS) Tunnelling Protocol for Control plane (GTPv2-C); Stage 3” v. 19.3.0, 13 Jun. 2025, hereinafter “TS 29.274”).

Upon receipt of the create session response message including the cause value set to #70 “Mandatory IE missing,” the MME 302 in the signaling diagram 300 or the ePDG 402 in the signaling diagram 400 may map the cause value set to #70 “Mandatory IE missing” to a cause value cause set to #95 “Semantically incorrect message” before forwarding the rejection message including the new cause value to the UE 104.

In scenarios involving 3GPP access to EPS, the MME 302 may map the cause value #70 “Mandatory IE missing” to the ESM cause value #95 “Semantically incorrect message”. This mapping may be added in Table C.1 in 3GPP TS 29.274. In scenarios involving untrusted non-3GPP access to EPS, the ePDG 402 may map the cause value #70 “Mandatory IE missing” to a private notify message, error type “SEMANTICALLY_INCORRECT_MESSAGE”. The private notify message, error type “SEMANTICALLY_INCORRECT_MESSAGE” may be used to update Table 8.1.2.2-1 of 3GPP TS 24.302.

In implementations (e.g., as illustrated in step 2 of the signaling diagrams 300, 400), the PGW-C+SMF may receive an activation request for the MA PDU connectivity service via the create session request message including the ePCO IE with the ATSSS request PCO parameter, e.g., as defined in 3GPP TS 24.193. Due to changes of the ATSSS parameter for steering functionalities in rel-19 and the newly adopted structure for rel-18 onwards for the ATSSS PCO parameter, the PGW-C+SMF from earlier releases than rel-19 may interpret that the ePCO IE with the ATSSS request PCO parameter:
indicates “ATSSS not supported” as defined in 3GPP TS 24.193; or
does not indicate any steering functionality or steering mode as defined in 3GPP TS 24.193.

The PGW-C+SMF from releases earlier than rel-19 may reject the PDN connection establishment procedure by generating the create session response message as shown in step 3 of the signaling diagrams 300, 400 to include the cause value set to #89 “Service denied.” The PGW-C+SMF may include the ATSSS parameter ATSSS status set to “Semantically incorrect message” which may be added to update table 6.1.5A.2-1 of 3GPP TS 24.193 in the ATSSS response. The ATSSS parameter may be implemented as a PCO parameter with a length of two octets in the ePCO IE. The encoding of the ATSSS parameter ATSSS status for “Semantically incorrect message” may be added to update Table 6.1.5A.2-1 of 3GPP TS 24.193, as in the following example.

TABLE
ATSSS parameter contents for ATSSS status
The ATSSS status is coded as follows:

| 8 | 7 | 6 | 5 | 4 | 3 | 2 | 1 | |
|---|---|---|---|---|---|---|---|---|
| 0 | 0 | 0 | 0 | 0 | 0 | 1 | 0 | Semantically incorrect message |

All other values are spare.

Upon receipt of the create session response message including the Cause value #89 “Service denied”: For 3GPP access to EPS, the MME may map the cause value set to #89 “Service denied” to the ESM cause value #31 “Request rejected, unspecified”. For untrusted non-3GPP access to EPS, it may be up to the implementation of the ePDG which private notify message error type value that the ePDG chooses to map the cause value #89 “Service denied” to.

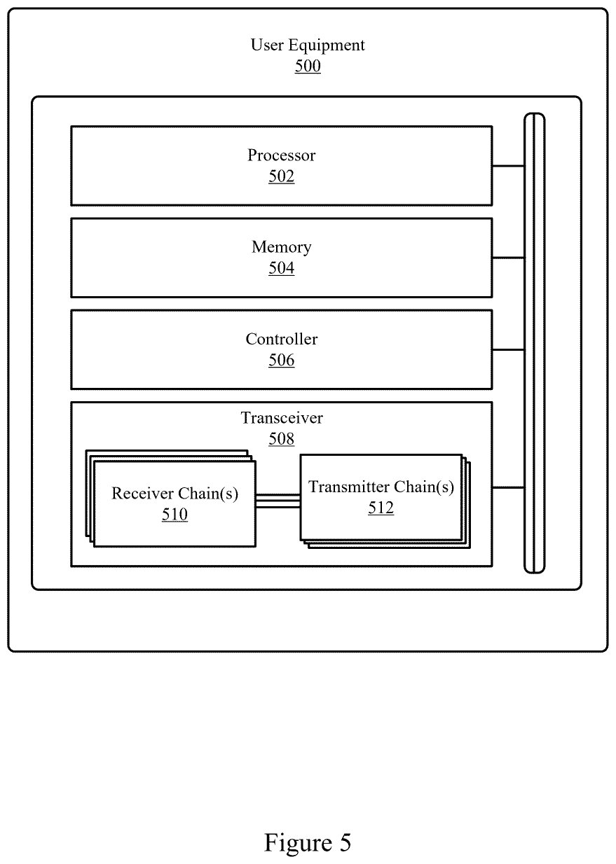

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to or operable to support a means for transmitting a first request for establishment of MA PDN connectivity, the first request including a first PCO IE or a first ePCO IE, where the first PCO IE or the first ePCO IE includes one or more ATSSS modes supported by the UE; and receiving an indication of a rejection of the first request, the indication including an indication of semantically incorrect message.

Additionally, the UE 500 may be configured to support any one or combination of where the indication of the rejection of the first request includes an ESM cause value #95 “Semantically incorrect message”; the indication of the rejection of the first request includes a private notify message of an error type “SEMANTICALLY_INCORRECT_MESSAGE”; the indication of the rejection of the first request includes a second PCO IE or a second ePCO IE, the second PCO IE or the second ePCO IE includes an ATSSS status associated with the rejection of the first request, and where the ATSSS status includes an indication of semantically incorrect message; the ATSSS status is indicated in the second ePCO IE via a parameter including two octets of bits; the one or more ATSSS steering modes supported by the UE include an indication of MPQUIC-IP functionality with steering mode without ATSSS-LL functionality; the first request is transmitted to one of a MME or an ePDG.

Additionally, or alternatively, the UE 500 may support at least one memory (e.g., the memory 504) and at least one processor (e.g., the processor 502) coupled with the at least one memory and configured to cause the UE to transmit a first request for establishment of MA PDN connectivity, the first request including a first PCO IE or a first ePCO IE, where the first PCO IE or the first ePCO IE includes one or more ATSSS modes supported by the UE; and receive an indication of a rejection of the first request, the indication including an indication of semantically incorrect message.

Additionally, the UE 500 may be configured to support any one or combination of where the indication of the rejection of the first request includes an ESM cause value #95 “Semantically incorrect message”; the indication of the rejection of the first request includes a private notify message of an error type “SEMANTICALLY_INCORRECT_MESSAGE”; the indication of the rejection of the first request includes a second PCO IE or a second ePCO IE, the second PCO IE or the second ePCO IE includes an ATSSS status associated with the rejection of the first request, and where the ATSSS status includes an indication of semantically incorrect message; the ATSSS status is indicated in the second ePCO IE via a parameter including two octets of bits; the one or more ATSSS steering modes supported by the UE include an indication of MPQUIC-IP functionality with steering mode without ATSSS-LL functionality; the first request is transmitted to one of a MME or an ePDG.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

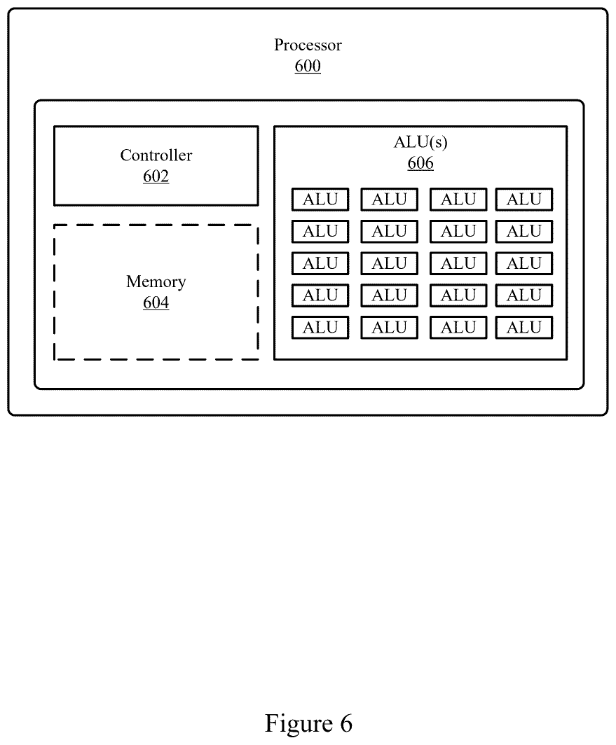

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside externally to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to transmit a first request for establishment of MA PDN connectivity, the first request including a first PCO IE or a first ePCO IE, where the first PCO IE or the first ePCO IE includes one or more ATSSS modes supported by the UE; and receive an indication of a rejection of the first request, the indication including an indication of semantically incorrect message.

Additionally, the processor 600 may be configured to or operable to support any one or combination of where the indication of the rejection of the first request includes an ESM cause value #95 “Semantically incorrect message”; the indication of the rejection of the first request includes a private notify message of an error type

“SEMANTICALLY_INCORRECT_MESSAGE”; the indication of the rejection of the first request includes a second PCO IE or a second ePCO IE, the second PCO IE or the second ePCO IE includes an ATSSS status associated with the rejection of the first request, and where the ATSSS status includes an indication of semantically incorrect message; the ATSSS status is indicated in the second ePCO IE via a parameter including two octets of bits; the one or more ATSSS steering modes supported by the UE include an indication of MPQUIC-IP functionality with steering mode without ATSSS-LL functionality; the first request is transmitted to one of a MME or an ePDG.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to transmit a first request for establishment of MA PDN connectivity for a UE, the first request including a first PCO IE or a first ePCO IE, where the first PCO IE or the first ePCO IE includes one or more ATSSS modes supported by the UE; receive a first message including a first indication of a rejection of the first request; and transmit a second message including a second indication of a rejection of the first request, the second indication including an indication of semantically incorrect message.

Additionally, the processor 600 may be configured to or operable to support any one or combination of where the second indication includes a cause value including an ESM cause value #95 “Semantically incorrect message”; the second indication includes a private notify message of an error type “SEMANTICALLY_INCORRECT_MESSAGE”; the second indication includes a second PCO IE or a second ePCO IE including an ATSSS status associated with the rejection of the first request, where the ATSSS status includes an indication of semantically incorrect message; the ATSSS status is indicated in the second ePCO IE via a parameter including two octets of bits; the first NE includes one of a MME or an ePDG; the first indication of the rejection of the first request includes an indication of a mandatory IE missing.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to receive a first request for establishment of MA PDN connectivity for a UE, the first request including a first PCO IE or a first ePCO IE, where the first PCO IE or the first ePCO IE includes one or more ATSSS modes of the UE; and transmit a first message including an indication of a rejection of the first request, the first message including an indication of ATSSS status of semantically incorrect message.

Additionally, the processor 600 may be configured to or operable to support any one or combination of where the ATSSS status is indicated in a second ePCO IE via a parameter including two octets of bits; the second NE includes a PGW-C+SMF; the first message is transmitted to an MME or an ePDG.

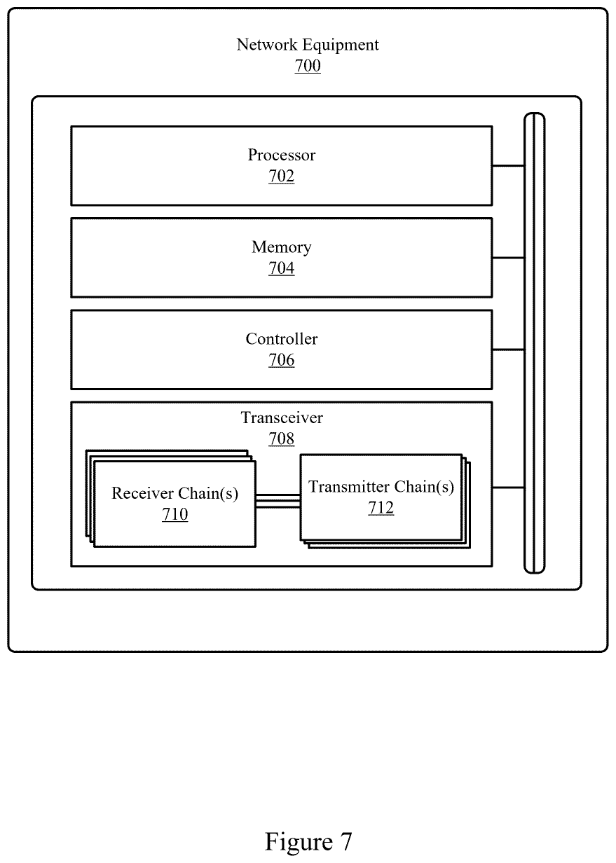

FIG. 7 illustrates an example of an NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein.

The NE 700 may be configured to or operable to support a means for transmitting a first request for establishment of MA PDN connectivity for a UE, the first request including a first PCO IE or a first ePCO IE, where the first PCO IE or the first ePCO IE includes one or more ATSSS modes supported by the UE; receiving a first message including a first indication of a rejection of the first request; and transmitting a second message including a second indication of a rejection of the first request, the second indication including an indication of semantically incorrect message.

Additionally, the NE 700 may be configured to or operable to support any one or combination of where the second indication includes a cause value including an ESM cause value #95 “Semantically incorrect message”; the second indication includes a private notify message of an error type “SEMANTICALLY_INCORRECT_MESSAGE”; the second indication includes a second PCO IE or a second ePCO IE including an ATSSS status associated with the rejection of the first request, where the ATSSS status includes an indication of semantically incorrect message; the ATSSS status is indicated in the second ePCO IE via a parameter including two octets of bits; the first NE includes one of a MME or an ePDG; the first indication of the rejection of the first request includes an indication of a mandatory IE missing.

Additionally, or alternatively, the NE 700 may support at least one memory (e.g., the memory 704) and at least one processor (e.g., the processor 702) coupled with the at least one memory and configured to cause the NE to transmit a first request for establishment of MA PDN connectivity for a UE, the first request including a first PCO IE or a first ePCO IE, where the first PCO IE or the first ePCO IE includes one or more ATSSS modes supported by the UE; receive a first message including a first indication of a rejection of the first request; and transmit a second message including a second indication of a rejection of the first request, the second indication including an indication of semantically incorrect message.

Additionally, the NE 700 may be configured to support any one or combination of where the second indication includes a cause value including an ESM cause value #95 “Semantically incorrect message”; the second indication includes a private notify message of an error type “SEMANTICALLY_INCORRECT_MESSAGE”; the second indication includes a second PCO IE or a second ePCO IE including an ATSSS status associated with the rejection of the first request, where the ATSSS status includes an indication of semantically incorrect message; the ATSSS status is indicated in the second ePCO IE via a parameter including two octets of bits; the first NE includes one of a MME or an ePDG; the first indication of the rejection of the first request includes an indication of a mandatory IE missing.

The NE 700 may be configured to or operable to support a means for receiving a first request for establishment of MA PDN connectivity for a UE, the first request including a first PCO IE or a first ePCO IE, where the first PCO IE or the first ePCO IE includes one or more ATSSS modes of the UE; and transmitting a first message including an indication of a rejection of the first request, the first message including an indication of ATSSS status of semantically incorrect message.

Additionally, the NE 700 may be configured to or operable to support any one or combination of where the ATSSS status is indicated in a second ePCO IE via a parameter including two octets of bits; the second NE includes a PGW-C+SMF; the first message is transmitted to an MME or an ePDG.

Additionally, or alternatively, the NE 700 may support at least one memory (e.g., the memory 704) and at least one processor (e.g., the processor 702) coupled with the at least one memory and configured to cause the NE to receive a first request for establishment of MA PDN connectivity for a UE, the first request including a first PCO IE or a first ePCO IE, where the first PCO IE or the first ePCO IE includes one or more ATSSS modes of the UE; and transmit a first message including an indication of a rejection of the first request, the first message including an indication of ATSSS status of semantically incorrect message.

Additionally, the NE 700 may be configured to support any one or combination of where the ATSSS status is indicated in a second ePCO IE via a parameter including two octets of bits; the second NE includes a PGW-C+SMF; the first message is transmitted to an MME or an ePDG.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

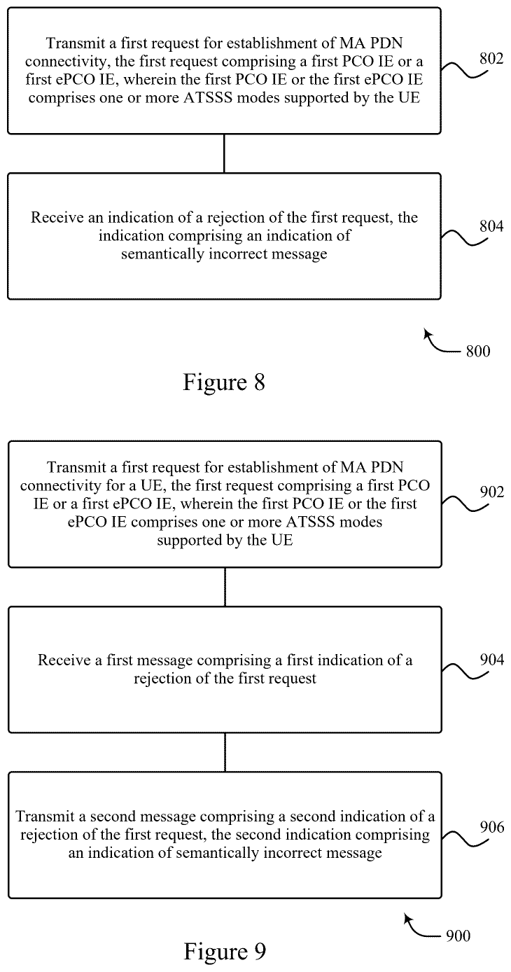

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include transmitting a first request for establishment of MA PDN connectivity, the first request comprising a first PCO IE or a first ePCO IE, where the first PCO IE or the first ePCO IE comprises one or more ATSSS modes supported by the UE. The operations of 802 may be performed in accordance with examples as described herein. In some implementations, aspects of the operations of 802 may be performed by a UE as described with reference to FIG. 5.

At 804, the method may include receiving an indication of a rejection of the first request, the indication comprising an indication of semantically incorrect message. The operations of 804 may be performed in accordance with examples as described herein. In some implementations, aspects of the operations of 804 may be performed by a UE as described with reference to FIG. 5.

FIG. 9 illustrates a flowchart of a method 900 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include transmitting a first request for establishment of MA PDN connectivity for a UE, the first request comprising a first PCO IE or a first ePCO IE, where the first PCO IE or the first ePCO IE comprises one or more ATSSS modes supported by the UE. The operations of 902 may be performed in accordance with examples as described herein. In some implementations, aspects of the operations of 902 may be performed by an NE as described with reference to FIG. 7.

At 904, the method may include receiving a first message comprising a first indication of a rejection of the first request. The operations of 904 may be performed in accordance with examples as described herein. In some implementations, aspects of the operations of 904 may be performed by an NE as described with reference to FIG. 7.

At 906, the method may include transmitting a second message comprising a second indication of a rejection of the first request, the second indication comprising an indication of semantically incorrect message. The operations of 906 may be performed in accordance with examples as described herein. In some implementations, aspects of the operations of 906 may be performed an NE as described with reference to FIG. 7.

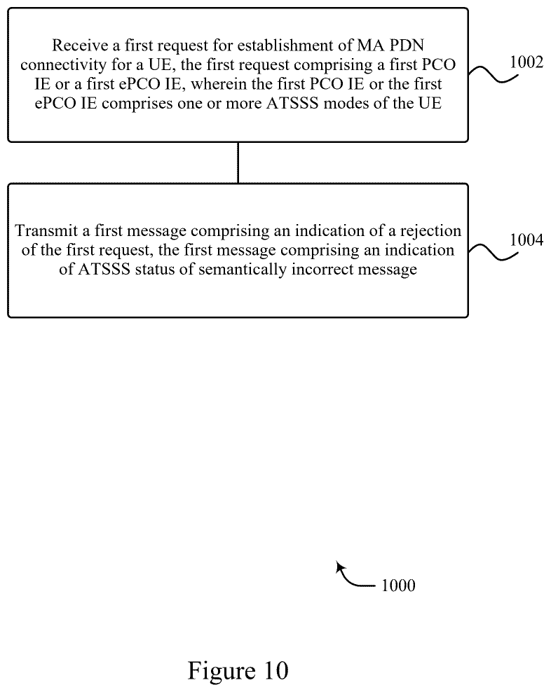

FIG. 10 illustrates a flowchart of a method 1000 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include receiving a first request for establishment of MA PDN connectivity for a UE, the first request comprising a first PCO IE or a first ePCO IE, where the first PCO IE or the first ePCO IE comprises one or more ATSSS modes of the UE. The operations of 1002 may be performed in accordance with examples as described herein. In some implementations, aspects of the operations of 1002 may be performed by an NE as described with reference to FIG. 7.

At 1004, the method may include transmitting a first message comprising an indication of a rejection of the first request, the first message comprising an indication of ATSSS status of semantically incorrect message. The operations of 1004 may be performed in accordance with examples as described herein. In some implementations, aspects of the operations of 1004 may be performed by an NE as described with reference to FIG. 7.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
transmit a first request for establishment of multiple access (MA) packet data network (PDN) connectivity, the first request comprising a first protocol configuration options (PCO) information element (IE) or a first extended PCO (ePCO) IE, wherein the first PCO IE or the first ePCO IE comprises one or more access traffic steering, switching, splitting (ATSSS) modes supported by the UE; and
receive an indication of a rejection of the first request, the indication comprising an indication of semantically incorrect message.

2. The UE of claim 1, wherein the indication of the rejection of the first request comprises an evolved packet system (EPS) session management (ESM) cause value #95 “Semantically incorrect message”.

3. The UE of claim 1, wherein the indication of the rejection of the first request comprises a private notify message of an error type “SEMANTICALLY_INCORRECT_MESSAGE”.

4. The UE of claim 1, wherein the indication of the rejection of the first request comprises a second PCO IE or a second ePCO IE, the second PCO IE or the second ePCO IE comprises an ATSSS status associated with the rejection of the first request, and wherein the ATSSS status comprises an indication of semantically incorrect message.

5. The UE of claim 4, wherein the ATSSS status is indicated in the second ePCO IE via a parameter comprising two octets of bits.

6. The UE of claim 1, wherein the one or more ATSSS steering modes supported by the UE comprise an indication of multipath quick user datagram protocol (UDP) connections (QUIC) for internet protocol (IP) packets (MPQUIC-IP) functionality with steering mode without ATSSS-lower layer (LL) functionality.

7. The UE of claim 1, wherein the first request is transmitted to one of a mobility management entity (MME) or an evolved Packet Data Gateway (ePDG).

8. A first network equipment (NE) for wireless communication, comprising:
at least one memory; and
at least one processor coupled with the at least one memory and operable to cause the NE to:
transmit a first request for establishment of multiple access (MA) packet data network (PDN) connectivity for a user equipment (UE), the first request comprising a first protocol configuration options (PCO) information element (IE) or a first extended PCO (ePCO) IE, wherein the first PCO IE or the first ePCO IE comprises one or more access traffic steering, switching, splitting (ATSSS) modes supported by the UE;
receive a first message comprising a first indication of a rejection of the first request; and
transmit a second message comprising a second indication of a rejection of the first request, the second indication comprising an indication of semantically incorrect message.

9. The first NE of claim 8, wherein the second indication comprises a cause value comprising an evolved packet system (EPS) session management (ESM) cause value #95 “Semantically incorrect message”.

10. The first NE of claim 8, wherein the second indication comprises a private notify message of an error type “SEMANTICALLY_INCORRECT_MESSAGE”.

11. The first NE of claim 8, wherein the second indication comprises a second PCO IE or a second ePCO IE comprising an ATSSS status associated with the rejection of the first request, wherein the ATSSS status comprises an indication of semantically incorrect message.

12. The first NE of claim 11, wherein the ATSSS status is indicated in the second ePCO IE via a parameter comprising two octets of bits.

13. The first NE of claim 8, wherein the first NE comprises one of a mobility management entity (MME) or an evolved packet data gateway (ePDG).

14. The first NE of claim 8, wherein the first indication of the rejection of the first request comprises an indication of a mandatory IE missing.

15. A second network equipment (NE) for wireless communication, comprising:
at least one memory; and
at least one processor coupled with the at least one memory and operable to cause the NE to:
receive a first request for establishment of multiple access (MA) packet data network (PDN) connectivity for a user equipment (UE), the first request comprising a first protocol configuration options (PCO) information element (IE) or a first extended PCO (ePCO) IE, wherein the first PCO IE or the first ePCO IE comprises one or more access traffic steering, switching, splitting (ATSSS) modes of the UE; and
transmit a first message comprising an indication of a rejection of the first request, the first message comprising an indication of ATSSS status of semantically incorrect message.

16. The second NE of claim 15, wherein the ATSSS status is indicated in a second ePCO IE via a parameter comprising two octets of bits.

17. The second NE of claim 15, wherein the second NE comprises a packet data network (PDN) gateway (PGW) control plane (PGW-C) plus session and mobility management function (SMF).

18. The second NE of claim 15, wherein the first message is transmitted to a mobility management entity (MME) or an evolved packet data gateway (ePDG).

19. A method performed by a user equipment (UE), the method comprising:
transmitting a first request for establishment of multiple access (MA) packet data network (PDN) connectivity, the first request comprising a first protocol configuration options (PCO) information element (IE) or a first extended PCO (ePCO) IE, wherein the first PCO IE or the first ePCO IE comprises one or more access traffic steering, switching, splitting (ATSSS) modes supported by the UE; and
receiving an indication of a rejection of the first request, the indication comprising an indication of semantically incorrect message.

20. The method of claim 19, wherein the indication of the rejection comprises one of:
an evolved packet system (EPS) session management (ESM) cause value #95 “Semantically incorrect message”;
a private notify message of an error type “SEMANTICALLY_INCORRECT_MESSAGE”; or
a second PCO IE or a second ePCO IE, the second PCO IE or the second ePCO IE comprising an ATSSS status associated with the rejection of the first request, and wherein the ATSSS status comprises an indication of semantically incorrect message.
